(19) United States
(12) Patent Application Publication
(10) Pub. No.: US 2005/0213788 A1
(43) Pub. Date: Sep. 29, 2005

(54) Acoustically active element formed in a multi-layer circuit-board structure, a method for forming acoustically active element in a multi-layer circuit-board structure, and a multi-layer circuit-board structure

(75) Inventors: Hannu Paarni, Salo (FI); Terho Kutilainen, Kiiminki (FI); Matti Uusikartano, Veikkola (FI); Auvo Penttinen, Helsinki (FI)

Correspondence Address: BIRCH STEWART KOLASCH & BIRCH, PO BOX 747, FALLS CHURCH, VA, 22040-0747, US

(73) Assignee: Asperation Oy, Espoo (FI)

(21) Appl. No.: 10/516,502

(22) PCT Filed: May 28, 2003
(86) PCT No.: PCT/FI03/00423

§ 371 Date: May 24, 2005

(30) Foreign Application Priority Data
Jun. 4, 2002 (FI) 20021069

(51) Int. Cl. H04R 1/02

(52) U.S. Cl. 381/386; 340/384.6

(57) ABSTRACT

This publication discloses an acoustically active element formed in a multi-layer circuit-board structure (20, 22, 24, 25), a method for manufacturing it, and a multi-layer circuit-board structure. The acoustically active element includes an internal chamber (21) and a membrane (18) or beam arranged in connection with the internal chamber (21), which acts as a vibrating element and is connected electrically to external circuits, in order to produce or measure an acoustic effect. According to the invention, the resonance chamber (21) is formed inside the multi-layer circuit-board structure (20, 22, 24, 25), in connection with the process of manufacturing the circuit board.

The present invention relates to an acoustically active element formed in a multi-layer circuit-board structure, according to the preamble of claim 1.

The invention also relates to a method for forming an acoustically active element in a multi-layer circuit-board structure, and to a multi-layer circuit-board structure.

Solutions of this kind are used are used in circuit-board technology, for forming acoustically active elements, such as loudspeakers, microphones, and sensors (acceleration, pressure, humidity, etc.).

According to the state of the art, the attachment of separate microphone components to a circuit board takes place as a separate operation.

A drawback of the state of the art is that a separate component requires a separate attachment operation. In addition, separate components take up quite a large amount of circuit-board space, which is a critical factor in complex circuit-board constructions. The most complex circuit-board constructions are used in applications such as mobile telephones and digital cameras.

The invention is intended to create a new type of acoustically active element for a multi-layer circuit-board structure, with the aid of which the drawbacks of the state of the art described above can be eliminated.

The invention is based on forming at least the internal chamber of the acoustically active element as part of the circuit-board structure, with the aid of circuit-board processes.

More specifically, the acoustically active element, according to the invention, formed in a multi-layer circuit-board structure is characterized by what is stated in the characterizing portion of claim 1.

The method according to the invention for forming an acoustically active element in a multi-layer circuit-board structure is, in turn, characterized by what is stated in the characterizing portion of claim 5.

The multi-layer circuit-board structure according to the invention is, in turn, characterized by what is stated in the characterizing portion of claim 9.

Considerable advantages are gained with the aid of the invention.

With the aid of the invention, the work stage required to attach an external component is eliminated. For example, in a mobile telephone application, both the microphone and the loudspeaker can, according to the invention, be formed in connection with the manufacture of the circuit board. At the same time, the circuitry required by the component is also formed. An integrated loudspeaker/microphone can also be made smaller than a separate component, thus saving space. If additional space can be gained on the circuit board, the overall reliability of the circuit-board manufacturing process will also improve, because manufacturing faults increase statistically in proportion to any increase in the packaging density.

In the following, the invention is examined with the aid of examples and with reference to the accompanying drawings.

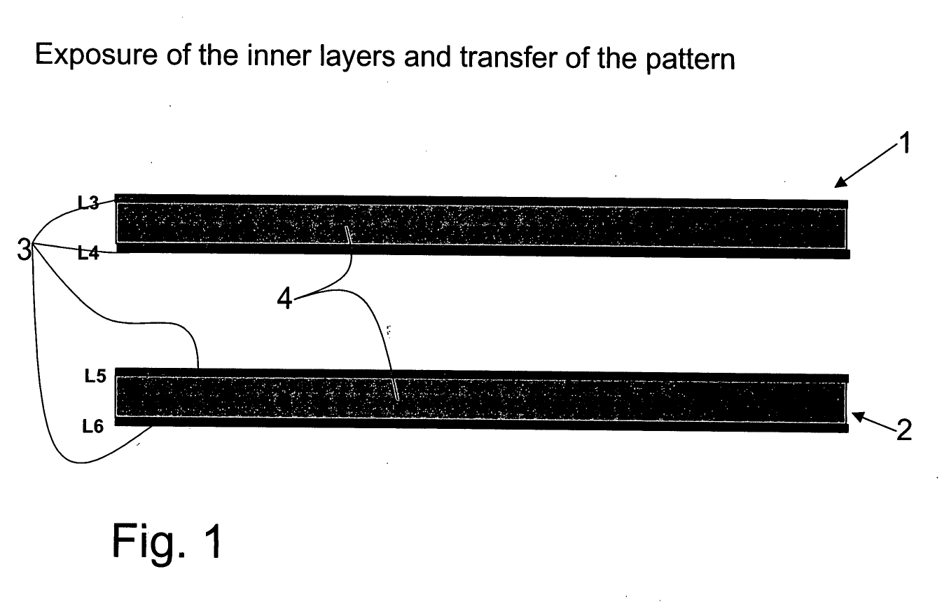

FIGS. 1-15 show cross-sectional side views of the circuit-board manufacturing process according to the state of the art, for instance, as follows:

FIG. 1: exposure of the inner layers and transfer of the pattern.

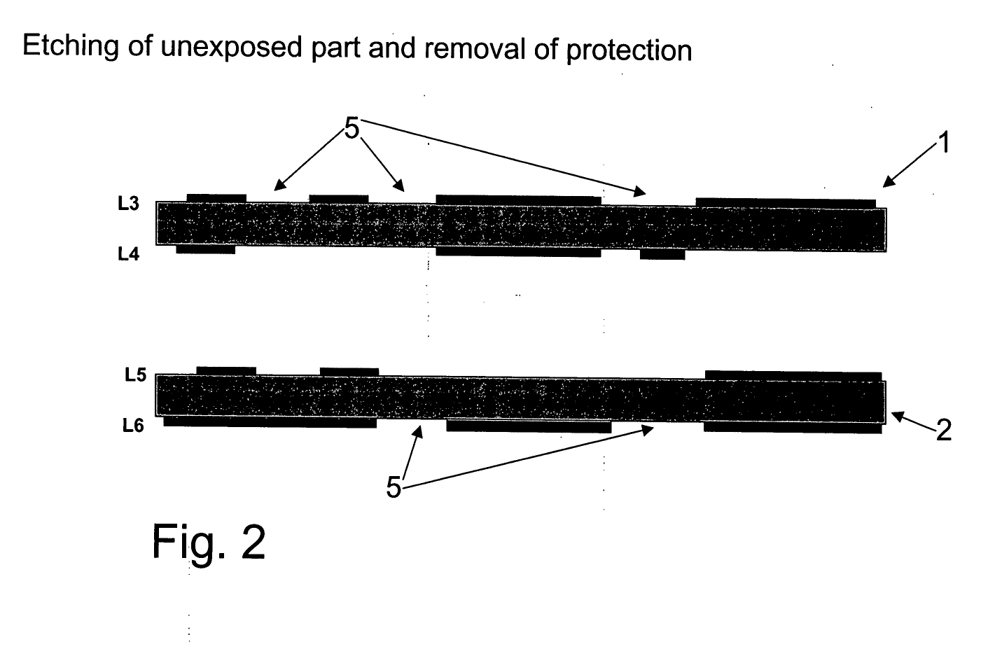

FIG. 2: etching of unexposed part and removal of protection.

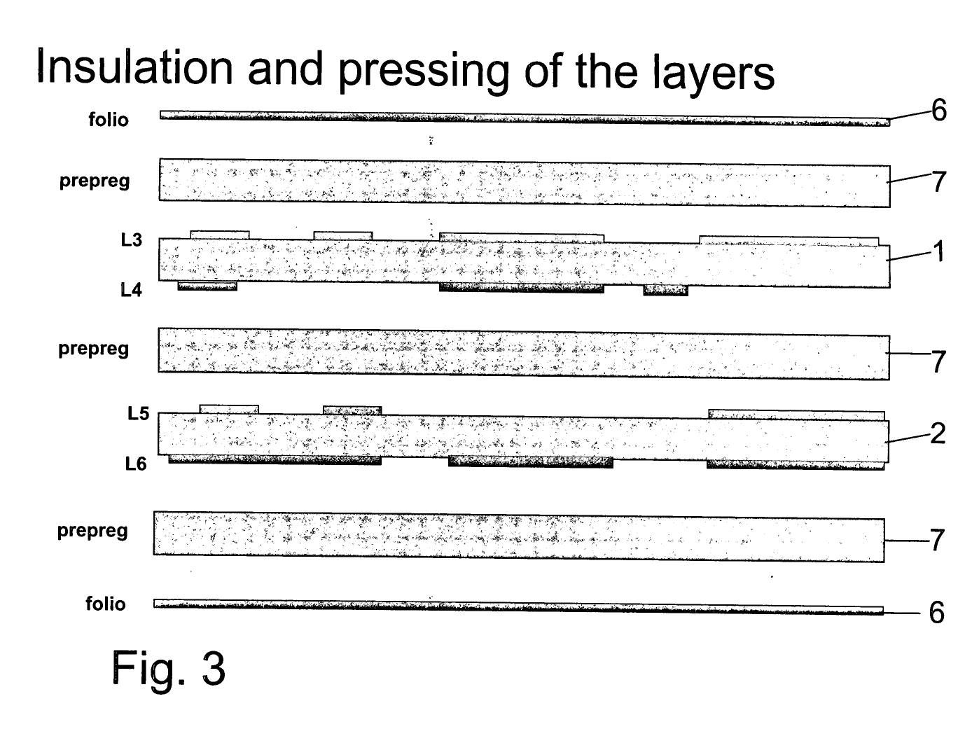

FIG. 3: insulation and pressing together of the layers.

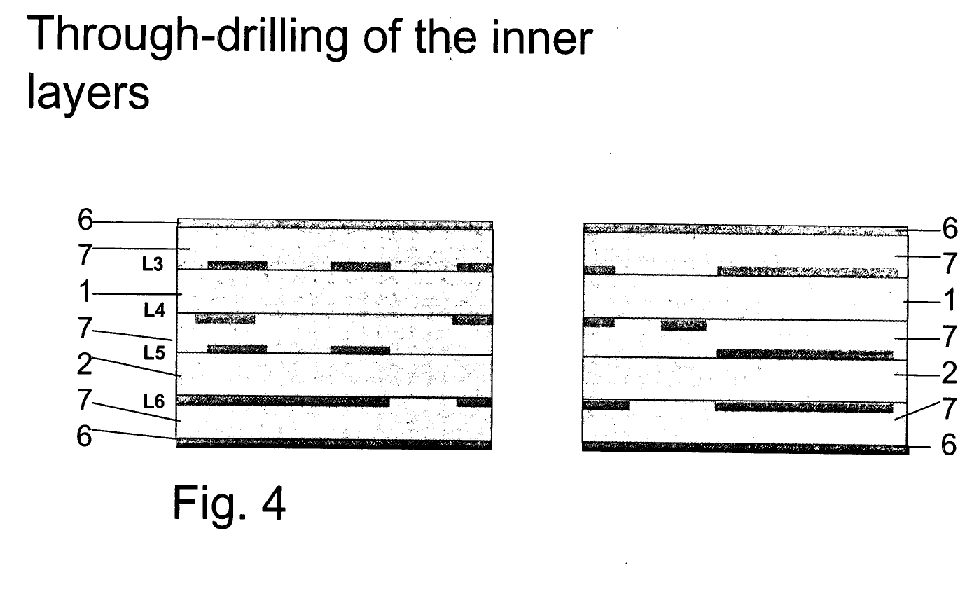

FIG. 4: through-drilling of the inner layers.

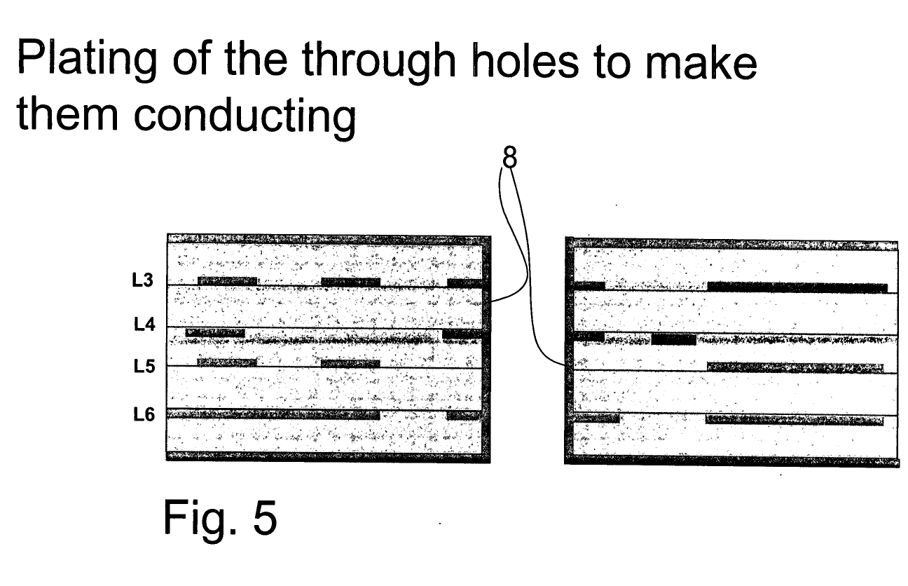

FIG. 5: plating of the through holes to make them conducting.

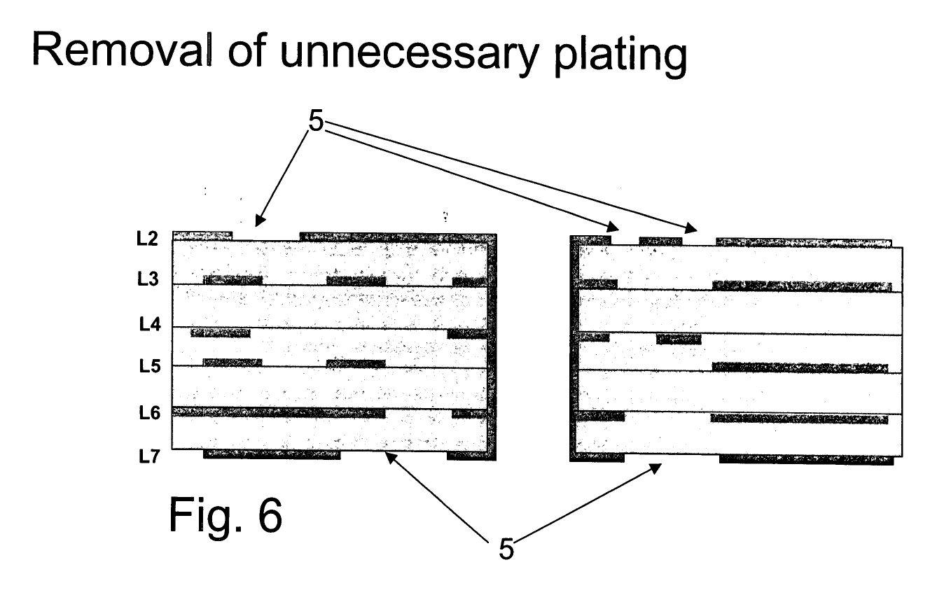

FIG. 6: removal of unnecessary plating.

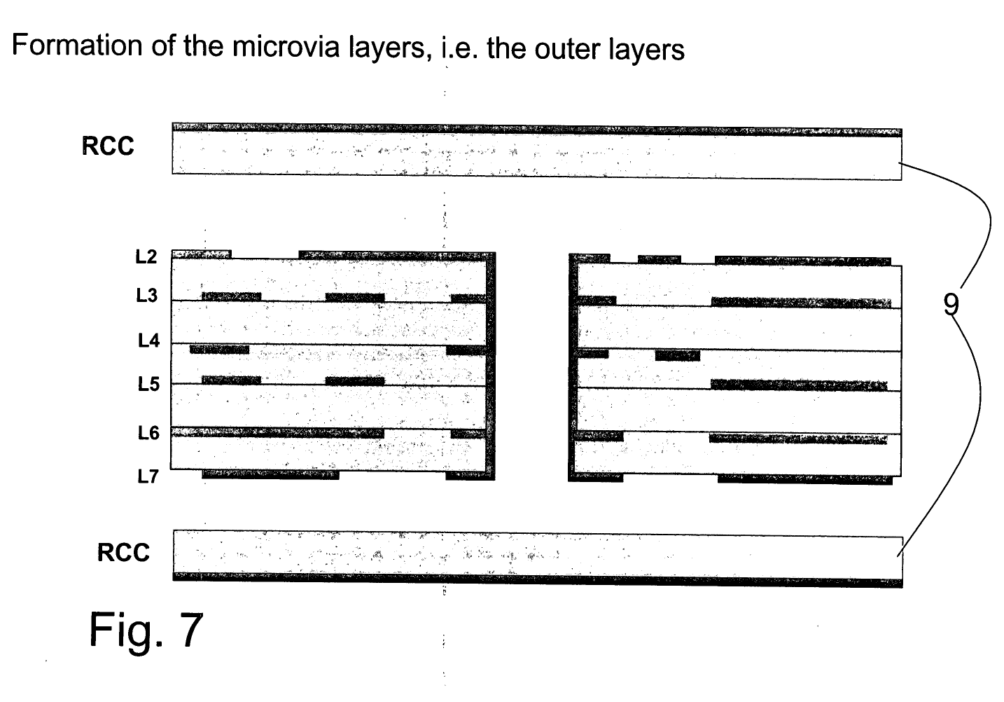

FIG. 7: formation of the microvia layers, i.e. the outer layers.

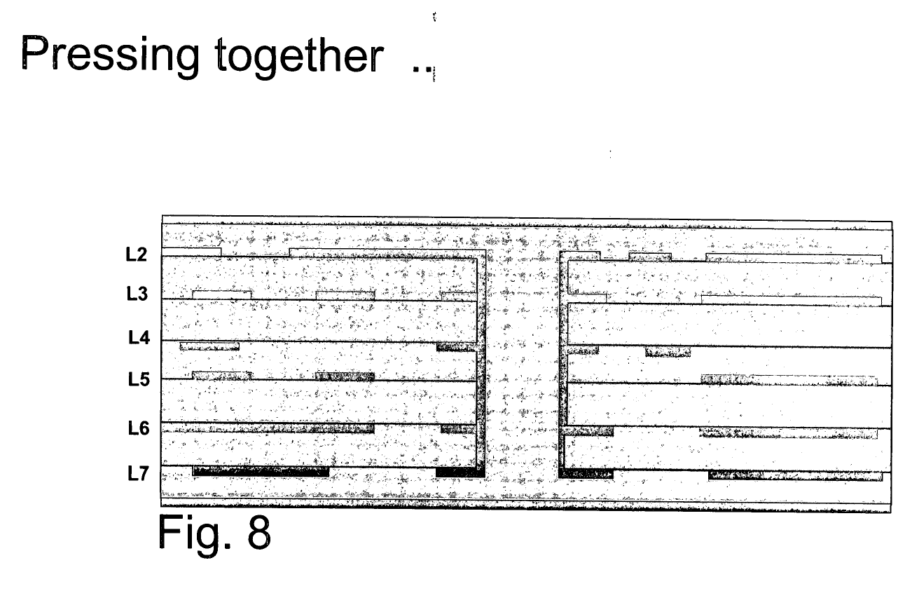

FIG. 8: pressing together.

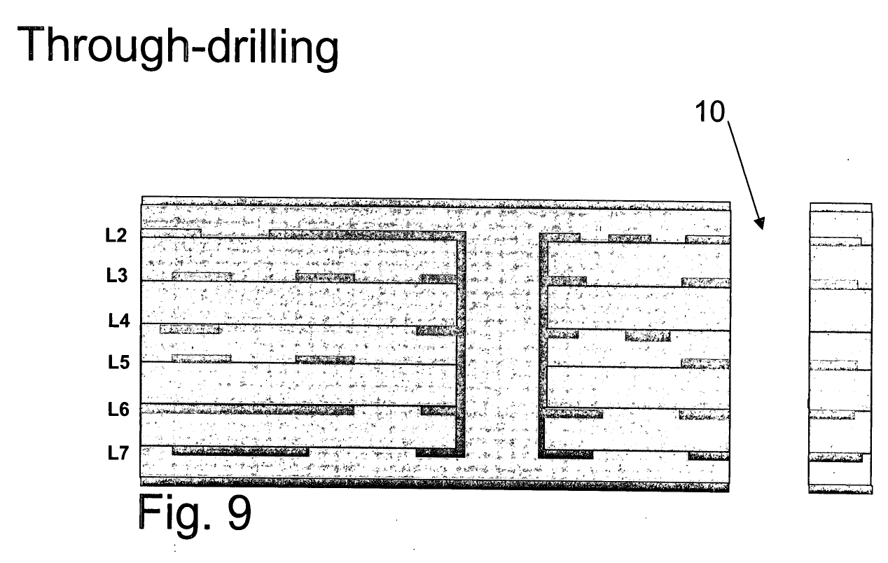

FIG. 9: through-drilling.

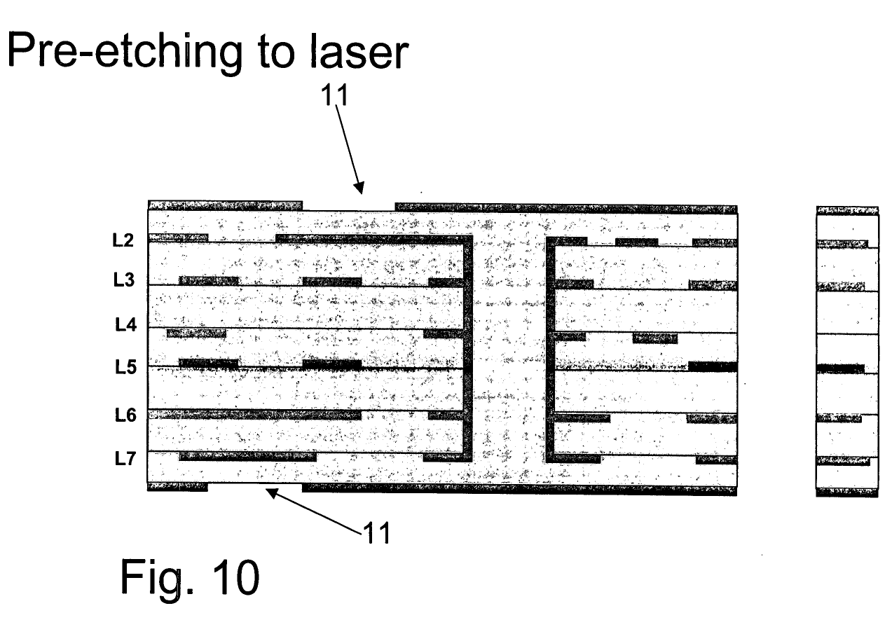

FIG. 10: pre-etching to laser.

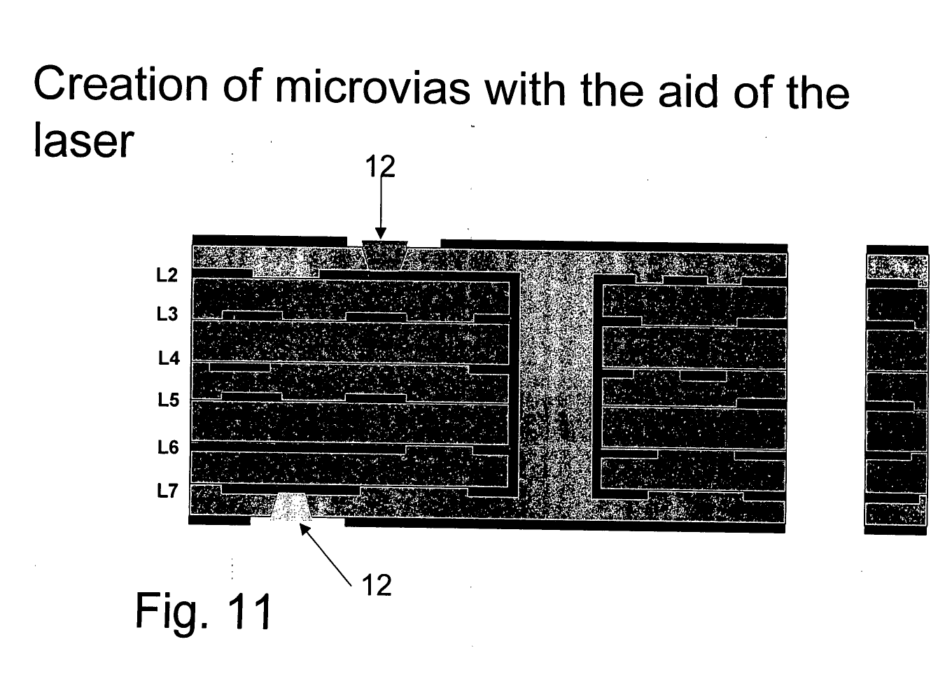

FIG. 11: creation of microvias with the aid of the laser.

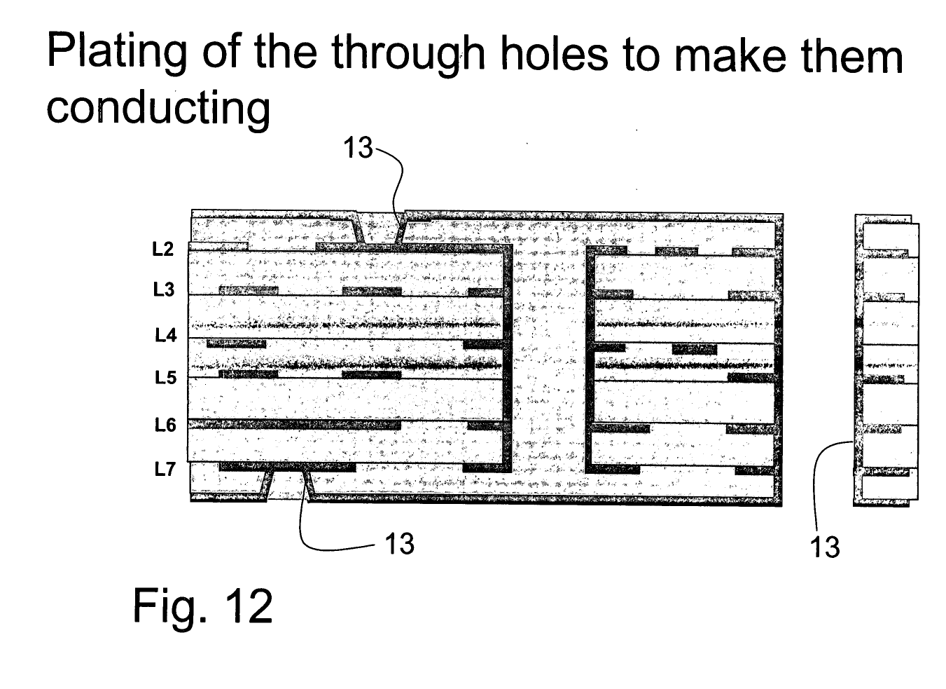

FIG. 12: plating of the through holes to make them conducting.

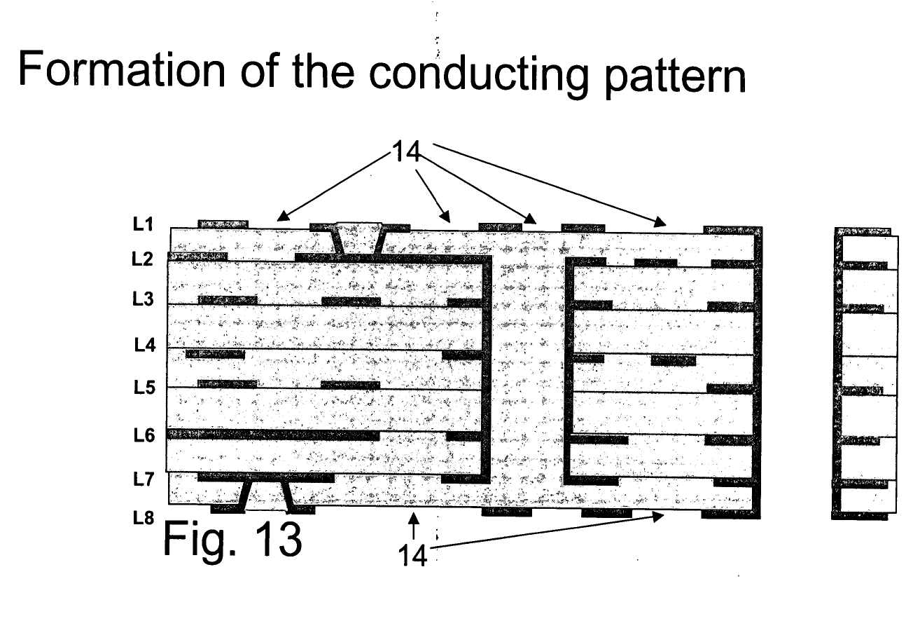

FIG. 13: formation of the conducting pattern.

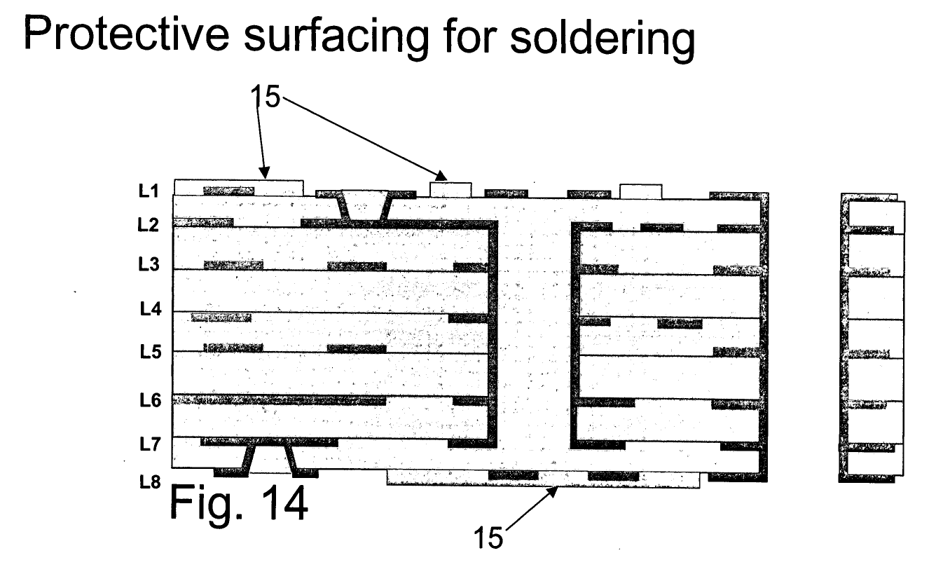

FIG. 14: protective surfacing for soldering.

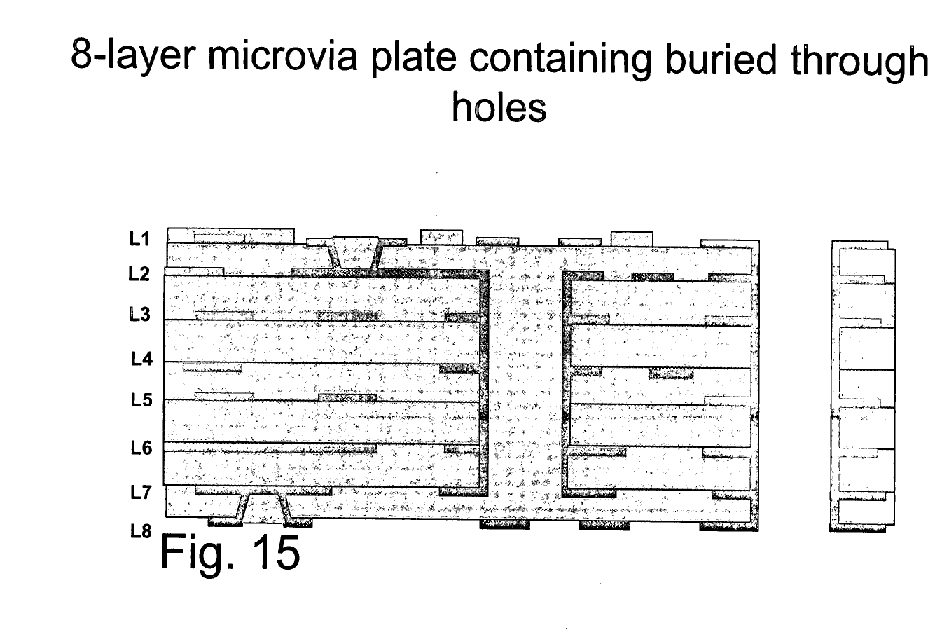

FIG. 15: end product, containing buried through holes.

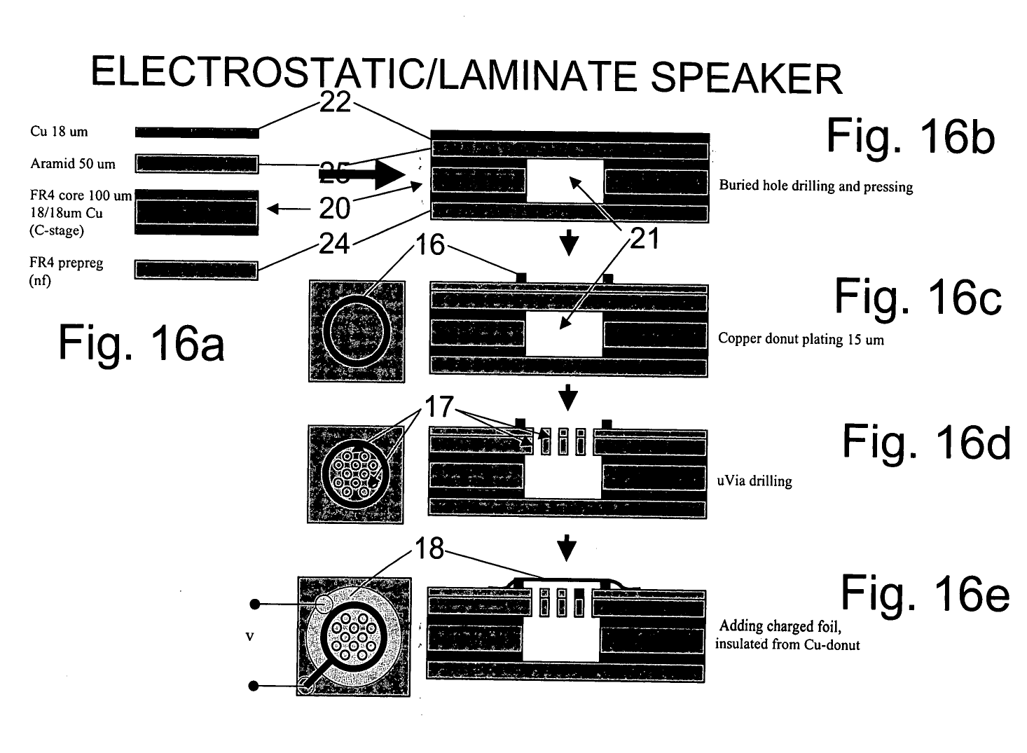

FIG. 16a-16e show cross-sectional side views of the stages of the method for forming a first acoustically active element, according to the invention, in a multi-layer circuit-board structure.

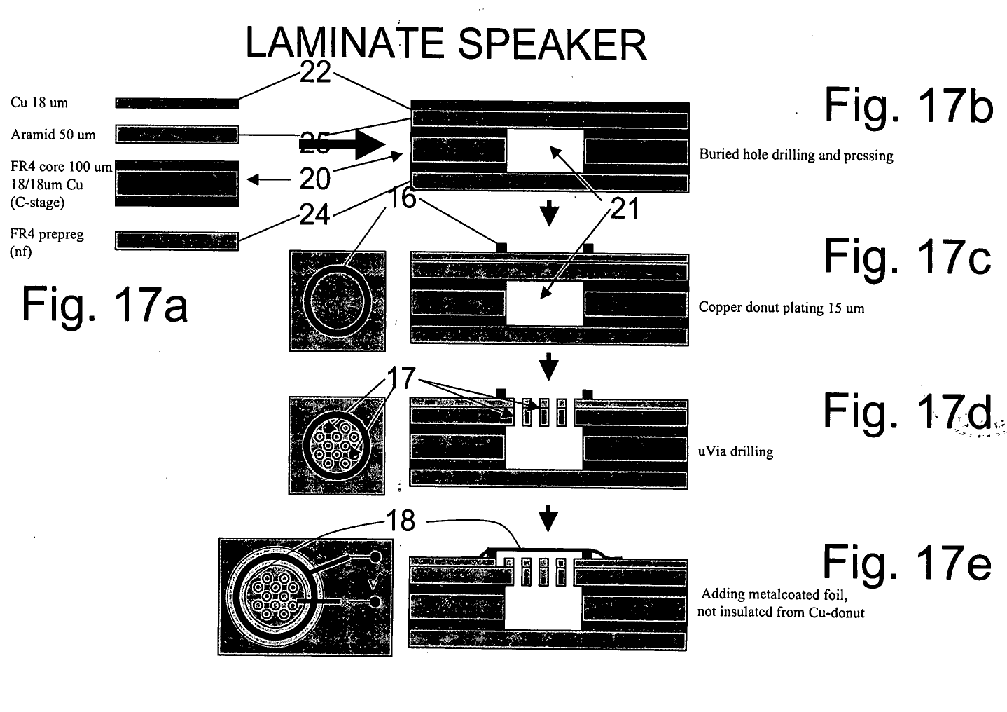

FIGS. 17a-17e show cross-sectional side views of the stages of the method for forming a second acoustically active element, according to the invention, in a multi-layer circuit-board structure.

The process according to FIG. 1 starts with the processing of an inner layer. The substrate of the inner layers 1 and 2 is generally glass-fibre-reinforced epoxy resin 4 (fibre reinforced organic substrate, FR4), which makes the board hard and sturdy. It is plated with copper foil 2, for the conductors and patterning. The through holes are mainly made by mechanical drilling. First of all, the circuit diagram is exposed (photolithography, imaging) on a light-sensitive material, from which the pattern is transferred to the active surface (copper plating) of the board (or of the layer to be processed). The first to be processed are the conducting surfaces 3 of the innermost circuit board blanks 1 and 2, which are separated from each other with insulating material 4.

The exposure stage demands clean rooms and special clothing for the operators. During ‘development’ a protective surface is formed on top of the copper in the pattern areas, while in the other areas the excess copper is etched away. This leads to an end result according to FIG. 2, in which the reference number 5 shows the areas, from which the conducting copper has been etched away.

Finally the protective material is washed off (stripped) from on top of the conductors. After this, only protective surface treatment remains to be carried out.

According to FIG. 3, insulating material (prepreg-) 7 is placed between the various layers while conducting layers are made on their outer surfaces. The various layers are pressed together (pressing) in a stage demanding precise positioning.

According to FIG. 4, the through holes are drilled, and, according to FIG. 5, are plated to become conducting. According to FIG. 6, the unnecessary conducting plating is removed, using the previously described photolithographic methods, the areas removed being shown in this case too with the reference number 5. The outer layers 9 (microvias) are formed according to FIGS. 7 and 8 and drill holes 10 running through the entire board are made according to FIG. 9. The areas 11 of the outer layers are pre-etched for the laser, according to FIG. 10. Microvias 12 are made in the areas 111 according to FIG. 11 and the through holes are plated 13, according to FIG. 12. According to FIG. 13, conducting patterns are further formed on the outermost conducting membranes, using the photolithographic methods described previously. After this, protective surfacing 15 is formed for soldering, the final result obtained being a structure according to FIG. 15, containing buried through holes. Finally, the board is finished and manufacturer's and code markings are made on it. Both optical and electrical testing takes place at the various stages of the process. As a totality, the end product can be divided into an outer layer, to which the external components are attached, and an inner layer, which implements the basic connections.

Generally there are about 20-40 process stages. The process demands expertise in chemistry and physics. In particular, it demands expertise in the theory of electricity and in physical chemistry.

The microvia layers 9 shown in FIGS. 7-9 are made as follows:

Depending on the application, the material substrates and processing processes of the outer layer and the inner layer may differ from each other.

In the latest devices (mobile telephones and new-generation base stations) a microvia layer 9 is the outer layer. This layer is used, because the increase in the number of component connections demands a reduction in the size of the through holes and conductors.

The microvias 12 (FIG. 11) are made by burning with a laser. In general, a through hole is termed a microvia, if its diameter is <100 microns, in which case mechanical drilling devices are insufficiently precise.

The vias 12 can be blind, in which case they terminate, for example, at layer L3. A buried via is a through hole that is not visible on the surface, but which runs, for example, between levels L2 and L3 (e.g., FIG. 6).

The material of the microvia layer 9 is usually RCC (Resin Coated Copper). The conductive outer plating is thin copper foil.

New technologies will increase the microvia layers. The term HDI (High Density Interconnection) board refers to a circuit board with a line width/spacing of <100 microns.

The process according to the invention for forming a loudspeaker, shown in FIGS. 16 and 17, basically follows the stages described above, all the materials being commercially available circuit-board materials.

The internal part 20 is normal FR4, described above, which is plated with copper. In the inner part, an interior chamber 21 is formed by normal circuit-board processes (routing or drilling) while the necessary conducting pattern is made on the surface 22, using lithography and etching.

The surface layers are formed as follows: on one side a socket 24 of FR4 and on the other a copper connecting layer 22, for example, insulated by aramid fibre 25. Lithography and etching are used to make the necessary conducting pattern on the connecting layer 22.

Aramid is an insulating fibre material using in the circuit-board industry, and is a normal commercially available material.

According to FIG. 16b, the layers are laminated together, by using normal circuit-board manufacturing devices.

According to FIG. 16c, an annular copper structure 16, which acts as a support structure for the acoustic membrane and if necessary as an intermediary for electrical contacts, is made in the multi-layer structure by image transfer, i.e. lithography. The process of growing the annular structure can be electrolytic or chemical (autocatalysis).

Inside the annular structure 16 microvias 17 are made to form acoustic channels, using normal circuit-board industry laser devices.

The acoustic membrane 18 is tensioned with the aid of the annular structure 18 and to the multi-layer structure by an adhesion substance.

According to FIG. 16e, the membrane 18 can be equipped with a permanent charge, or alternatively metallized according to FIG. 17e. In these alternative embodiments, the conductor pattern and the manner of routing the signals is different; in the former case (FIG. 16e) the charge of the membrane acts as the bias while in the latter (FIG. 17e) it is a separate voltage led under the membrane, in which case the signal is taken to the metallized membrane 18.

1. An acoustically active element formed in a multi-layer circuit-board structure (20, 22, 24, 25), which includes
an internal chamber (21), and
a membrane (18) or beam arranged acoustically in connection with the internal chamber (21), which acts as a vibrating element and is connected electrically to external circuits, in order to produce or measure an acoustic effect,
characterized in that
the internal chamber (21) is formed inside the multi-layer circuit-board construction (20, 22, 24, 25), in connection with the process of manufacturing the circuit board.

2. An acoustically active element according to claim 1, characterized in that the membrane (18) acting as a vibrating element is stretched on top of an annular element (16) formed in the multi-layer circuit-board structure (20, 22, 24, 25).

3. An acoustically active element according to claim 1 or 2, characterized in that the membrane (18) acting as a vibrating element is electrically charged.

4. An acoustically active element according to any of the above claims, characterized in that the annular element (18) is formed from copper on the surface of the multi-layer circuit-board structure.

5. A method for forming an acoustically active element in a multi-layer circuit-board structure, in which method the multi-layer circuit-board structure is formed of alternating insulating (25, 24) and conducting layers (22), contacts being formed between the conducting layers (22), and conducting structures being imaged in the conducting layers,
characterized in that
an acoustic internal chamber (21) is formed inside the multi-layer circuit-board structure (20, 22, 24, 25),
the internal chamber is opened (17) if necessary to the surface of the circuit board, and
a membrane (18) capable of vibrating is formed on top of the internal chamber (21) opened to the surface.

6. A method according to claim 6, characterized in that the internal chamber (21) is opened using the microvia technique.

7. A method according to claim 5 or 6, characterized in that an annular structure (16), on top of which the membrane (18) capable of vibrating is installed, is formed on the surface of the circuit board.

8. A method according to any of the above claims, characterized in that the membrane (18) capable of vibrating is electrically charged.

9. A multi-layer circuit-board structure, which includes
alternating insulating (25, 24) and conducting layers (22),
contacts formed between the conducting layers (22), and
conducting structures forming patterns in the conducting layers,
characterized in that the multi-layer circuit-board structure includes
a built-in acoustic internal chamber (21), and
a membrane (18) capable of vibrating formed on top of the internal chamber (21).

10. A multi-layer circuit-board structure according to claim 9, characterized in that the membrane (18) acting as a vibrating element is stretched on top of an annular element (16) formed in the multi-layer circuit-board structure (20, 22, 24, 25).

11. A multi-layer circuit-board structure according to claim 9 or 10, characterized in that the membrane (18) capable of vibrating is electrically charged.

12. A multi-layer circuit-board according to any of the above claims, characterized in that an annular element (18) is formed from copper on the surface of the multi-layer circuit-board structure.
